(19) United States
(12) Patent Application Publication
(10) Pub. No.: US 2004/0203515 A1
(43) Pub. Date: Oct. 14, 2004

(54) Arrangement of receptacle and mobile device

(75) Inventor: Kazunari Kuriyama, Hyogo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, TOKYO (JP)

(21) Appl. No.: 10/282,132

(22) Filed: Oct. 29, 2002

(30) Foreign Application Priority Data
May 2, 2002 (JP) 2002-130387

(51) Int. Cl. H04B 1/38; H04M 1/00

(52) U.S. Cl. 455/90.3; 455/569.1

(57) ABSTRACT

An arrangement of a receptacle, in which a plug can easily be fitted when in use without increasing thickness of a casing around the receptacle of a mobile device, and a mobile device are obtained. In the arrangement of a receptacle for arranging a receptacle, in which a plug is fitted, inside a casing of a mobile phone device, the receptacle is arranged such that the plug is inserted from a side end portion of mobile phone device, and a notch is provided on the side end portion of the casing so as to expose at least a prescribed area of the side portion of receptacle.

### BACKGROUND OF THE INVENTION

1. Field of the Invention

The present invention relates to an arrangement of a receptacle in which a plug is inserted, and to a mobile device. More particularly, the present invention relates to an arrangement of a receptacle for an earphone jack in which receptacle an earphone plug is fitted, and to a mobile device including a receptacle for an earphone jack.

2. Description of the Background Art

In mobile audio equipment or a mobile device to which an earphone is connected, an earphone receptacle for using the earphone is usually provided on the body. Recently, as mobile audio equipment or mobile phone devices are becoming thinner, sometimes a receptacle provided on a mobile phone device cannot be accommodated within the range of the thickness of the device when, for example, a receptacle for a ring contact is used, because the plug diameter becomes relatively large. FIG. 29 shows a state when an earphone plug is inserted into an earphone receptacle provided on a conventional slim-type mobile phone device. FIG. 30 is a cross-sectional view taken along the line XXX-XXX shown in FIG. 29. An earphone plug 105 has a ring contact 105b on its bottom portion, in addition to a plug terminal 105a. A part 103p to accommodate the ring is formed at an earphone receptacle 107 on the body of the mobile phone device. The part is formed on a casing 103 of the mobile phone device, and protrudes from a surface of the casing toward the outside.

As shown in FIG. 31, when the earphone plug is detached, earphone receptacle 107 is exposed. For dustproof or drip-proof purpose, earphone receptacle 107 is covered with a cap 108 as shown in FIG. 32.

In the arrangement of the earphone receptacle as described above, a convex portion is provided, which increases the thickness of the slim-type mobile phone device at the end portion. Such convex portion may degrade the appearance and impair the functionally advantageous slim design of the slim-type mobile phone device.

### SUMMARY OF THE INVENTION

An object of the present invention is to provide an arrangement of a receptacle in which a plug can easily be fitted when in use, without increasing thickness of a casing around the receptacle when a receptacle for an electrical connection is provided on a side portion of electronic equipment such as a mobile phone device, and to provide a mobile device.

An arrangement of a receptacle of the present invention is for arranging a receptacle, in which a plug is fitted, inside a casing of electronic equipment. In this arrangement, the receptacle is arranged such that the plug is inserted from a side portion of the casing, and a notch is provided on an end portion of the casing so as to expose at least a side portion of the receptacle.

Naturally, front side of a receptacle has been exposed. A bulge (convex shape) that impairs the design of a casing can be eliminated by not enclosing a prescribed area of the side portion such as a corresponding portion to a ring contact, that is, by exposing the portions including the side portion of the receptacle as described above. Fitting of the plug will not be interfered if the dimension of the notch is larger than a prescribed size, even when the bulge is not provided. The above-mentioned parts not enclosed with the casing can be covered with a cap or the like when not in use, since dusts or liquid may easily attach to such parts. This cap for unused time is advantageous to fill discontinuity of the casing at the portion of the notch, and to ensure the functionally advantageous slim design as a slim-type casing, for example.

The arrangement of a receptacle described above is for arranging a receptacle, in which a plug is fitted, inside a casing of electronic equipment. This arrangement includes an opening/closing mechanism that opens and closes a part of the casing near the receptacle.

By accommodating the receptacle within the casing when not in use, and opening the aforementioned part of the casing for use, the state will easily be changed to the state where the interference of the casing in fitting the plug is easily prevented. The receptacle may be moved concurrently with, or after the actuation of the above-mentioned opening mechanism. In addition, entry of dusts or liquid into the receptacle from the outside can be prevented.

A mobile device of the present invention is provided, within a casing thereof, with a receptacle in which a plug is fitted. The mobile device includes an arrangement of the receptacle wherein a portion of the casing fronting to at least a side portion of the receptacle is not provided.

With this structure, it is possible to ensure the functionally advantageous slim design of the slim-type mobile device by covering the receptacle with a cap when not in use, and to prevent the interference of the casing in fitting the plug when the receptacle is used, without providing a bulge portion on the casing of the slim-type mobile device. In addition, the aforementioned cap can implement dustproof or drip-proof receptacle. It is to be noted that, the casing may be removed from the whole circumference of the receptacle for an earphone. Furthermore, the arrangement of the receptacle may implement the above-mentioned state only when the earphone plug is fitted. That is, it is unnecessary in the receptacle arrangement that the portion of the casing, which portion fronts to at least a prescribed area of the side portion of the earphone receptacle, is always provided around the earphone receptacle.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an arrangement of a receptacle in a first embodiment of the present invention.

FIG. 2 is a perspective view showing a state when a plug is fitted in the receptacle shown in FIG. 1.

FIG. 3 is an enlarged view of the periphery of the plug shown in FIG. 2.

FIG. 4 is a plan view of the arrangement of the receptacle shown in FIG. 2.

FIG. 5 is a cross-sectional view taken along the line V-V in FIG. 4.

FIG. 6 is a perspective view showing a state when the arrangement of the receptacle shown in FIG. 1 is covered with a cap.

FIG. 7 is an exploded perspective view of a mobile phone device having the arrangement of the receptacle shown in FIG. 1.

FIG. 8 is a perspective view showing a receptacle having top and bottom surfaces cut away in order to be accommodated in a slim-type casing.

FIG. 9 is a perspective view of a plug having a ring contact.

FIG. 10 is a perspective view showing a state when the plug is fitted in the receptacle.

FIG. 11 is a plan view of FIG. 10.

FIG. 12 is a cross-sectional view taken along the line XII-XII in FIG. 11.

FIG. 13 is a perspective view showing a state when a plug is fitted in an arrangement of a receptacle in a second embodiment of the present invention.

FIG. 14 is a perspective view showing the receptacle when the plug is detached.

FIG. 15 shows a state when the receptacle is covered with a cap.

FIG. 16 is a plan view showing an arrangement of a receptacle in a third embodiment of the present invention.

FIG. 17 is a plan view showing a step when a part of a casing starts an opening operation.

FIG. 18 is a plan view showing a step when the part of the casing has completed the opening operation and the receptacle is exposed from the casing.

FIG. 19 is a plan view showing an arrangement of a receptacle in a fourth embodiment of the present invention.

FIG. 20 is a plan view showing a step when, in the arrangement of the receptacle shown in FIG. 19, one surface of a corner portion of a casing opens, and the other surface, together with the receptacle, protrudes from the surface.

FIG. 21 is a cross-sectional view showing an arrangement of a receptacle in a fifth embodiment of the present invention.

FIG. 22 is a cross-sectional view showing a step when, in the arrangement of the receptacle shown in FIG. 21, a cap opens, and the receptacle pivots around a hinge so as to be exposed to the outside of a casing.

FIG. 23 is a plan view showing an arrangement of a receptacle in a sixth embodiment of the present invention.

FIG. 24 is a plan view showing a step when, in the arrangement of the receptacle shown in FIG. 23, a movable substrate arranged in a corner portion pivots around a hinge to expose the receptacle from a casing.

FIG. 25 is a cross-sectional view showing an arrangement of a receptacle in a seventh embodiment of the present invention.

FIG. 26 is a cross-sectional view showing a step when, in the arrangement of the receptacle shown in FIG. 25, the receptacle pivots around a hinge so as to be exposed to the outside of a casing.

FIG. 27 is a cross-sectional view showing an arrangement of a receptacle in an eighth embodiment of the present invention.

FIG. 28 is a cross-sectional view showing a step when, in the arrangement of the receptacle shown in FIG. 27, the receptacle pivots around a hinge so as to be exposed to the outside of a casing.

FIG. 29 is a perspective view showing a conventional arrangement of a receptacle.

FIG. 30 is a cross-sectional view taken along the line XXX-XXX shown in FIG. 29.

FIG. 31 is a perspective view showing a state when a plug is detached from the arrangement of the receptacle shown in FIG. 29.

FIG. 32 is a perspective view showing a state when the receptacle shown in FIG. 31 is covered with an attached cap.

### DESCRIPTION OF THE PREFERRED EMBODIMENTS

Embodiments of the present invention will now be described with reference to the drawings.

### First Embodiment

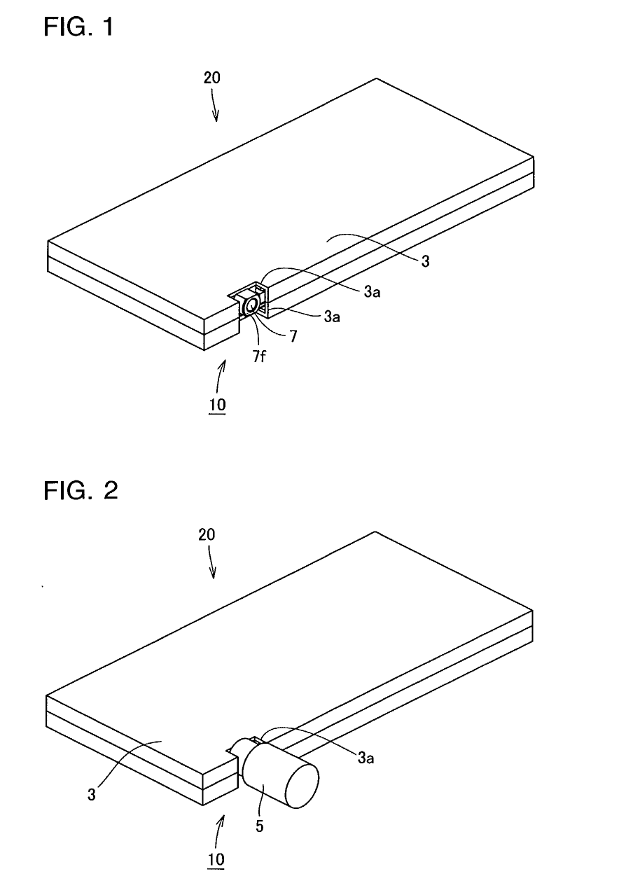

FIG. 1 is a perspective view showing an arrangement 10 of a receptacle in a first embodiment of the present invention. A receptacle 7 is provided on a slim-type mobile phone device 20. A characteristic of this embodiment is that, receptacle 7 is formed within a notch (recess portion) 3a provided on a casing 3 of mobile phone device 20 and is exposed. The receptacle is arranged to be accommodated within the side end portion of the casing. Front 7f of the receptacle corresponds to a front portion when viewed from the direction to which a plug is fitted in the receptacle.

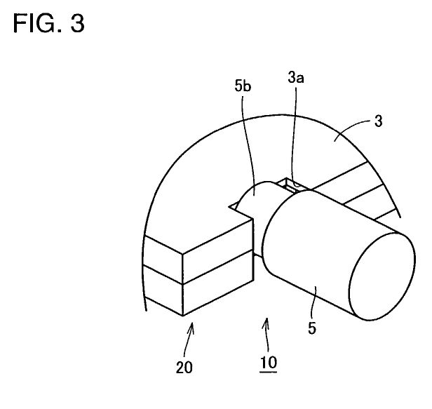

FIG. 2 is a perspective view showing a state when an earphone plug 5 is fitted in receptacle 7. Earphone plug 5 having a ring contact as described above can smoothly be fitted because notch 3a is provided such that receptacle 7 has a space therearound. FIG. 3 is an enlarged view of the periphery of the earphone plug shown in FIG. 2. As shown in FIG. 3, a ring portion 5b of earphone plug 5 has a portion existing at a position higher than the surface of the casing of the slim-type mobile phone device.

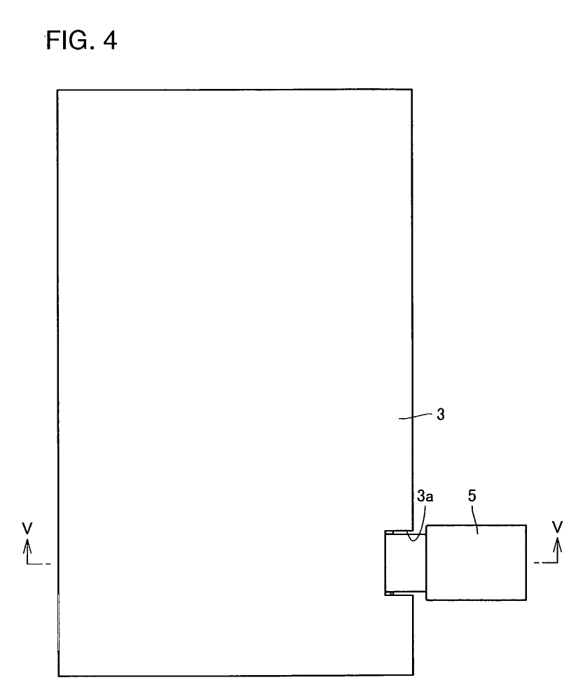

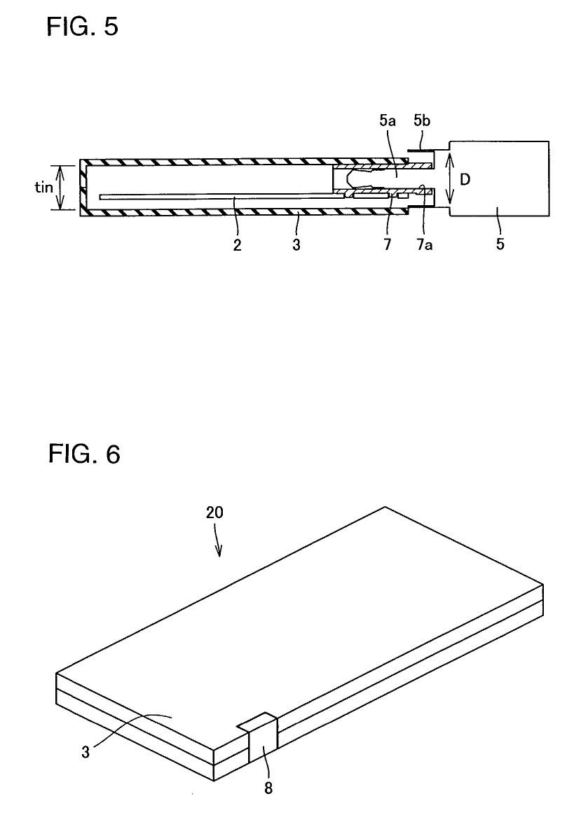

FIG. 4 is a plan view of the mobile phone device shown in FIG. 2. FIG. 5 is a cross-sectional view taken along the line V-V in FIG. 4. In FIG. 5, a connecting portion of earphone plug 5 is arranged on a plug terminal 5a and ring portion 5b. A plurality of connecting portions divided with insulator are formed on the plug terminal. Receptacle 7 is attached to a circuit board 2. FPC (Flexible Print Circuit) may be employed in place of circuit board 2. According to FIG. 5, ring portion 5b of earphone plug 5 has a diameter D which is larger than an inside thickness tin of casing 3. Thus, when the earphone is connected, ring portion 5b has a portion exposed at a position higher than the casing.

FIG. 6 shows a state when notch 3a accommodating the receptacle is covered with a lid 8 for dustproof or drip-proof purpose, when the earphone is not used. As the notch is covered with lid 8, the design of the slim-type mobile phone device is not impaired when it is not used.

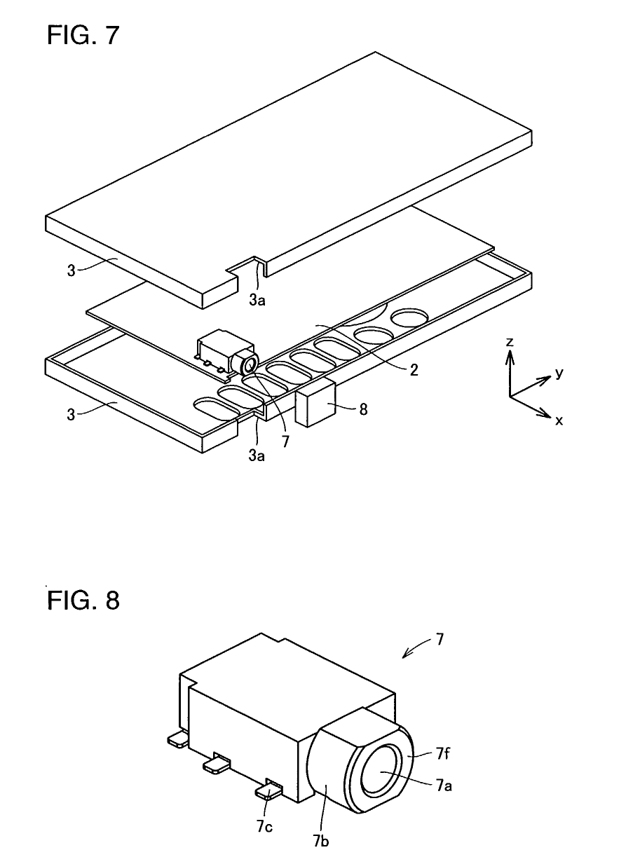

FIG. 7 is an exploded perspective view of the above-described mobile phone device. Casings 3 each having notch 3a are arranged above and below substrate 2 to sandwich the substrate therebetween. Receptacle 7 is arranged on substrate 2, and is positioned such that a prescribed tip portion of receptacle 7 is exposed at notch 3a. The casing without the notch is restored by covering notch 3a with lid 8, thereby ensuring the design of the slim-type casing.

FIG. 8 is a perspective view showing receptacle 7. When the casing has a flat shape as described above, the receptacle is made to have a flat surface which intersects the direction of the thickness of the casing. That is, top and bottom portions of receptacle 7 are flattened as if they are cut away so that the receptacle and the substrate are accommodated inside the slim-type casing. By such reduction of the thickness, the above-mentioned flat surface is formed on the receptacle. Receptacle 7 also has a terminal 7c to be electrically connected with a connection terminal of the substrate. A connecting portion to contact with an internal portion of ring portion 5b of the earphone plug is provided on a prescribed position on a ring contact arrangement portion 7b, which is an outer portion of a cylindrical hole 7a in which the plug terminal is inserted. Front 7f of the receptacle corresponds to a front portion when viewed from the direction to which a plug is fitted in the receptacle.

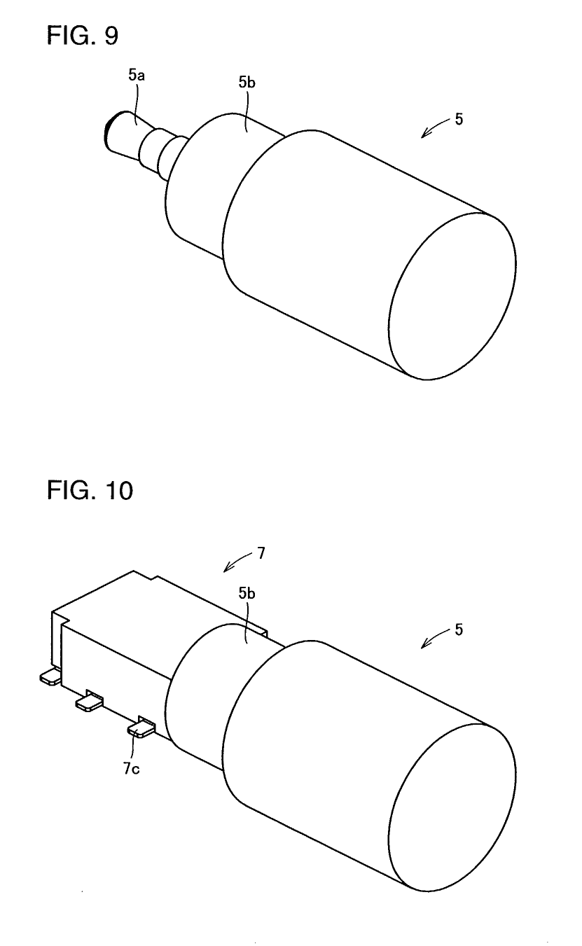

FIG. 9 is a perspective view of earphone plug 5. Plug terminal 5a is fitted in cylindrical hole 7a, and the internal surface of ring portion 5b is connected to the outer surface of cylindrical hole 7a. FIG. 10 shows a state when the earphone plug is fitted in the receptacle.

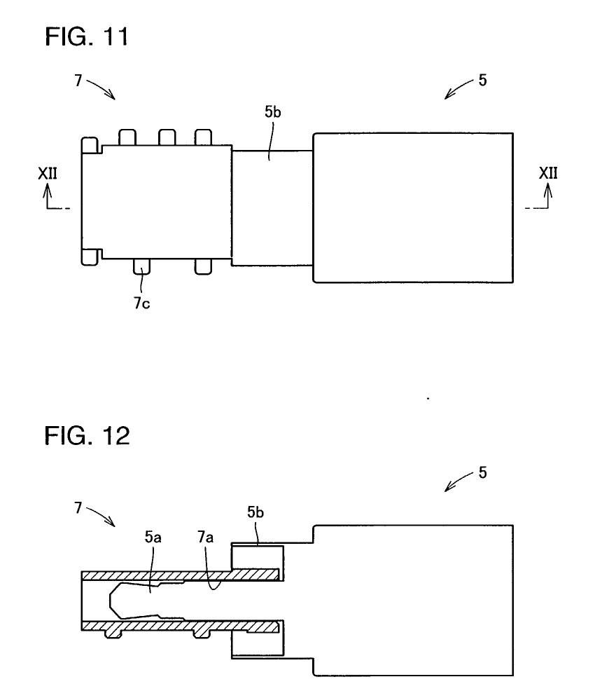

FIG. 11 is a plan view showing a state when the receptacle and the earphone plug are fitted. FIG. 12 is a cross-sectional view taken along the line XII-XII in FIG. 11. In this drawing, the receptacle is only shown by the portion of the cylindrical hole. The plug terminal has a plurality of connecting portions with the insulator and, in a connection state, plug terminal 5a is inserted into cylindrical hole 7a of the receptacle and electrically connected with a portion provided on that position of the side wall of the cylindrical hole which corresponds to each of the plurality of the above-mentioned connecting portions.

In this embodiment, when not covered with the lid, the receptacle is accommodated in the notch of the casing in an exposed state, whereby the earphone plug can easily be fitted in the receptacle. On the other hand, when covered with the lid, the notch becomes continuous from the casing of the slim-type mobile phone device and does not impair the design of the slim-type mobile phone device.

In other words, in this embodiment, both (a) the usability of the earphone and (b) the design while not using the earphone can be attained by (a) notching only a prescribed portion, around the receptacle, of the casing and (b) filling the notched portion, without moving the receptacle.

### Second Embodiment

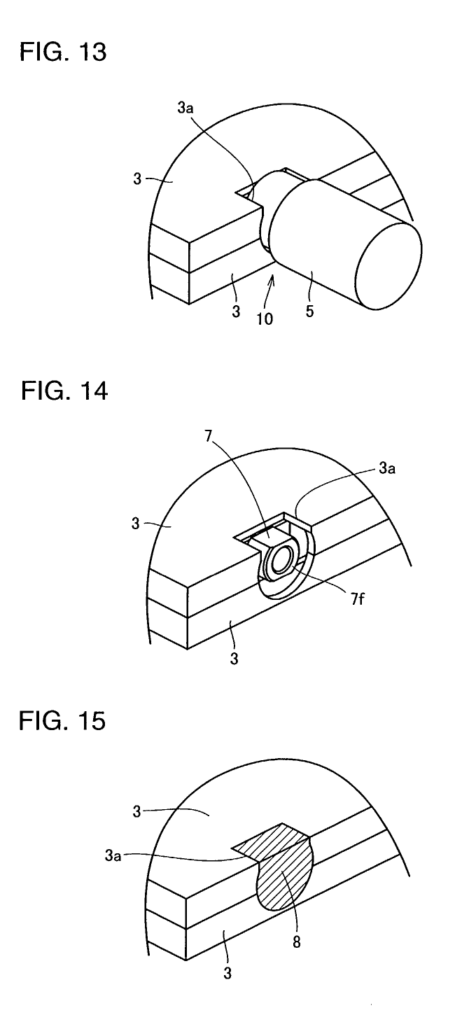

FIGS. 13-15 are perspective views showing an arrangement of a receptacle in a second embodiment of the present invention. A characteristic of this embodiment is that, a cost for notching the casing is minimized. As shown in FIGS. 13 and 14, the portion of the casing where a bulge has been conventionally formed is cut away. This embodiment differs from the first embodiment only in the form of the notch and hence the form of the cap, as shown in FIG. 15.

By minimizing the forms of the notch and the cap as described above, when the cap is detached, the impression of discontinuity or imperfection of the notch to the casing can be made minimal. In addition, since the notch is not provided on the casing below the receptacle, the entry of dusts or liquid into the receptacle at least from the downside can be prevented. Furthermore, decrease of the strength is in a tolerable range.

### Third Embodiment

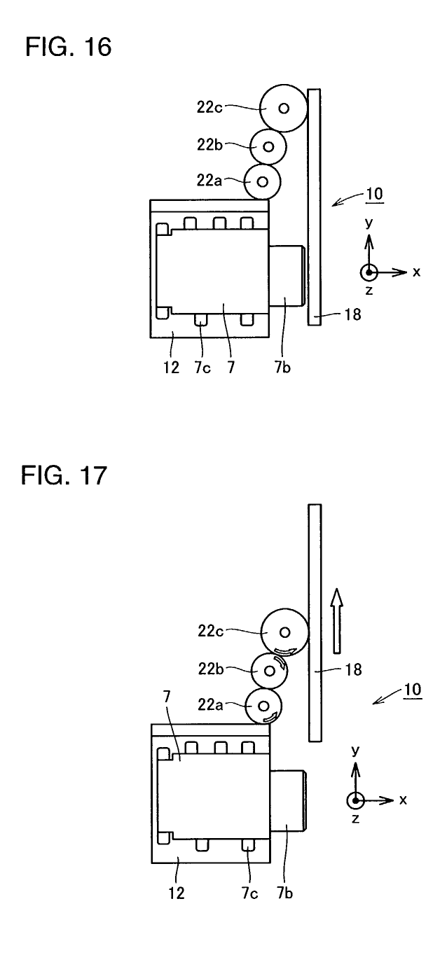

FIGS. 16-18 are plan views showing an arrangement of a receptacle in a third embodiment of the present invention. A characteristic of this embodiment is that, a mounting receptacle module, including earphone receptacle 7 mounted on a movable substrate 12, is made movable in the direction of the x axis separately from body substrate 2. As shown in FIG. 16, when the earphone is not used, earphone receptacle 7 is accommodated within the casing covered with a cap. Gears 22a, 22b and 22c joined to each other are arranged between the casing portion or cap 18 and mounting receptacle module 12. The gears function as a linkage that gears an opening/closing mechanism to a receptacle moving mechanism.

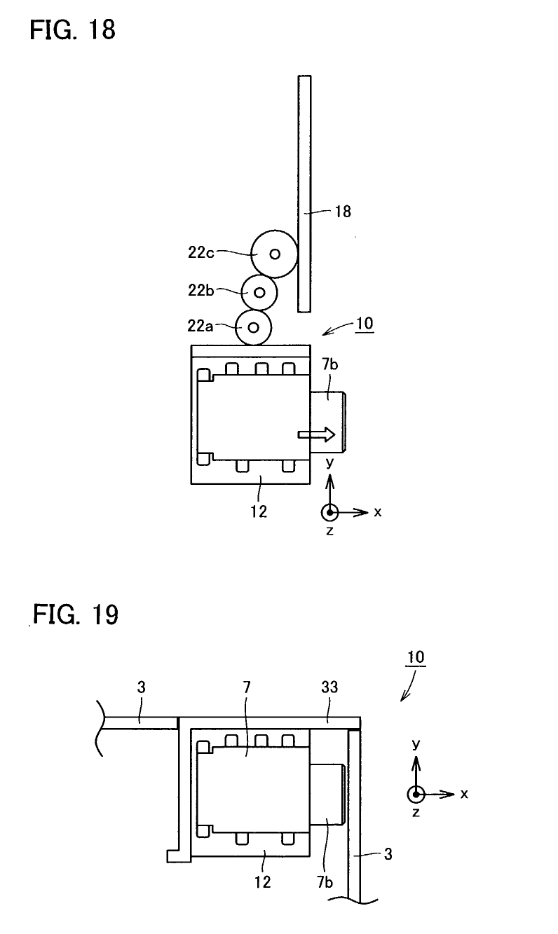

As shown in FIG. 17, while the cap is moved in the direction of the y axis and an aperture is provided on the casing, gear 22c rotates counterclockwise, which makes gear 22b rotate clockwise and gear 22a rotate counterclockwise. From the counterclockwise rotation of gear 22a, mounting receptacle module 12 receives a force in the direction of the x axis, which is the direction to protrude from the casing. FIG. 18 is a plan view showing a state when mounting receptacle module 12 is exposed to the outside of the casing through the aperture provided by the movement of the cap.

In FIGS. 16-18, the structure is shown wherein the earphone receptacle is automatically exposed to the outside of the casing by the movement of the cap. It is unnecessary, however, to gear the movement of the cap to the movement of the mounting receptacle module. The mounting receptacle module can also protrude from the casing with another mechanism such as a manual operation, after the aperture is formed by the movement of the cap in the direction of the y axis.

With the structure described above, the design of the slim-type mobile phone device while not using the earphone is not impaired and, when in use, the earphone receptacle is exposed from the casing to allow the easy fitting of the earphone plug having the ring contact.

### Fourth Embodiment

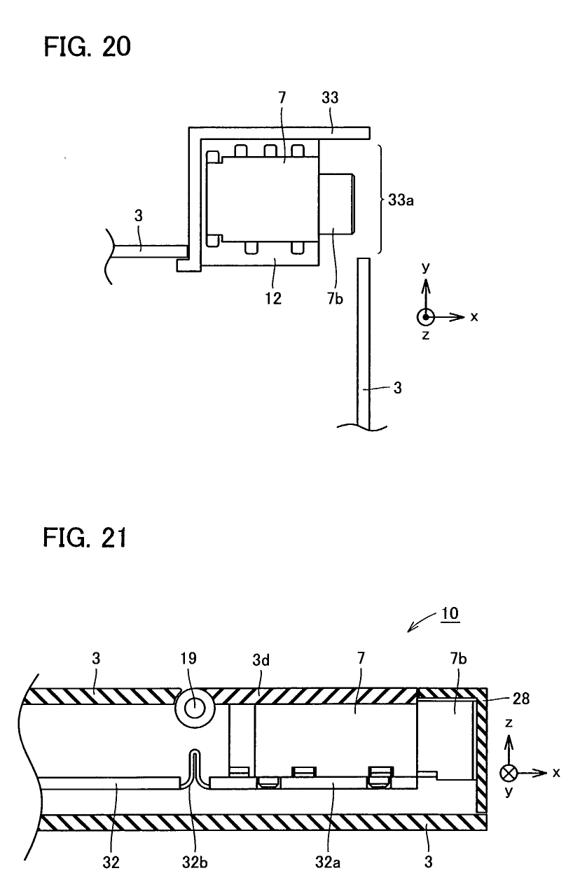

FIGS. 19 and 20 are plan views showing an arrangement of a receptacle in a fourth embodiment of the present invention. A characteristic of this embodiment is that, receptacle 7 having the cylindrical hole directed along the x axis is arranged in a corner portion of the casing, and the mounting receptacle module including receptacle 7 mounted on movable substrate 12 is moved in the direction of the y axis. In FIG. 19, a mounting receptacle module cap 33 is arranged on the side surface of the corner portion, which side surface is extending in the direction of the x axis. Mounting receptacle module cap 33 is joined to mounting receptacle module 12, and moves along with the movement of mounting receptacle module 12.

FIG. 20 shows the arrangement after mounting receptacle module 12 has moved in the direction of the y axis. Notch 33a is provided by the movement of mounting receptacle module 12 and mounting receptacle module cap 33 in the direction of the y axis. In this notch 33a, the structure is formed wherein the casing is not arranged on upside and downside of mounting receptacle module 12. Since this notch is formed in the corner portion, which is different from the notch shown in FIG. 1, the receptacle is exposed more than in the accommodating portion of the receptacle of FIG. 1.

The arrangement of the receptacle described above is more generally expressed as follows. The arrangement of the receptacle can include the following mechanism: while the front side of the receptacle is kept facing one side wall forming a corner portion, the other wall portion forming the corner is separated and moved, together with the receptacle, away from the one side wall to protrude outer from that the other side wall.

With this arrangement, a structure similar to the notch can be provided on the corner portion. Thus, the plug can be fitted with less interference than in the case of the notch provided on the side surface.

With the aforementioned structure, the appearance of the slim-type mobile phone device is not impaired when the earphone is not used, and when the earphone is used, the receptacle can be protruded from the casing with the exposure higher than that in the structure in the first embodiment.

### Fifth Embodiment

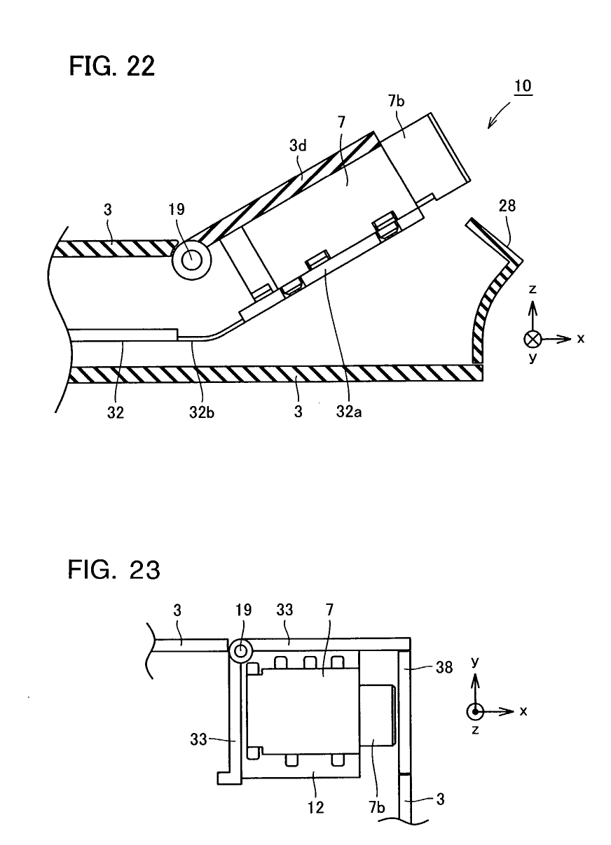

FIGS. 21 and 22 show an arrangement of an earphone receptacle in a fifth embodiment of the present invention. A characteristic of this embodiment is that, the earphone receptacle and a substrate portion 32a are made pivotable around the y axis.

In this arrangement 10 of the earphone receptacle, receptacle 7 is arranged on movable substrate 32a as shown in FIG. 21. A body substrate 32 is joined to the movable substrate with a joint portion 32b. When the earphone is not used, a portion of extra length in joint portion 32b is arranged in an overlapping form along the direction of the z axis. Receptacle 7 is arranged on a receptacle substrate portion 32a which is a movable substrate located nearer to the end side than joint portion 32b.

A hinge 19 is arranged on the end portion of casing 3 of the body, and a pivoting casing portion 3d which pivots around the hinge is provided. The direction of the axis of hinge 19 is the direction of the y axis. That is, the hinge axis is parallel to the longitudinal direction of the mobile phone device. In addition, a cap 28 which opens toward the outside is formed at the end of the casing in the direction of the x axis.

As shown in FIG. 22, after opening cap 28, pivoting casing portion 3d is pivoted around hinge 19, whereby receptacle substrate portion 32a is pivoted. This pivoting of receptacle substrate portion 32a unfolds the overlap of joint portion 32b to accept a curvature of the substrate at the outer side corresponding to a curvature of the casing at the inner side. As a result of such pivoting, ring contact arrangement portion 7b of receptacle 7 is exposed to the outside.

As the aforementioned cap 28, a rubber-like elastic body may be used or, as shown in FIG. 22, an opening mechanism may be provided.

With the structure described above, the design of the slim-type casing while not using the earphone is not impaired and, when using the earphone, the earphone receptacle is exposed to allow the easy fixing of the earphone plug.

### Sixth Embodiment

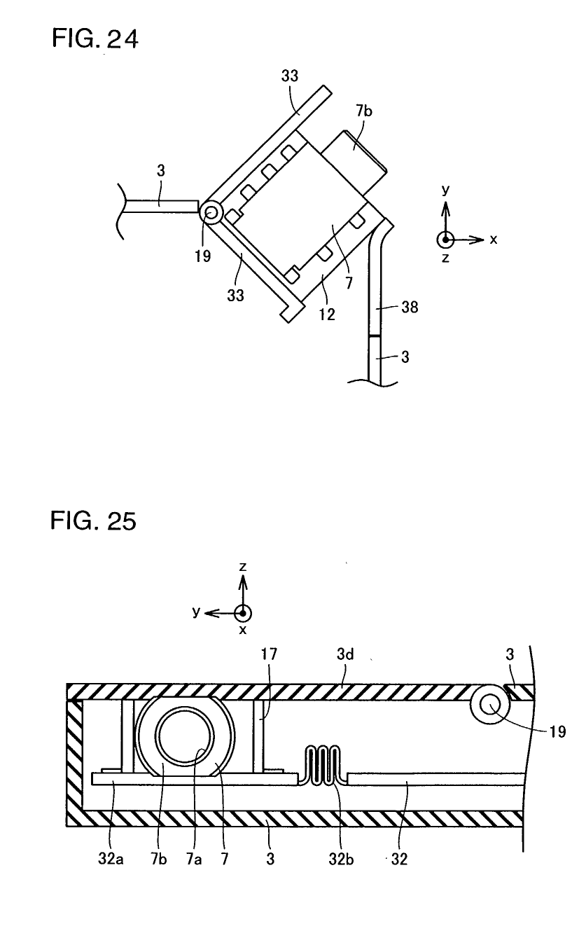

FIGS. 23 and 24 are plan views showing an arrangement of an earphone receptacle in a sixth embodiment of the present invention. In FIG. 23, earphone receptacle 7 is mounted on mounting receptacle module substrate 12, and is arranged in a corner portion. Mounting receptacle module cap 33 is attached to mounting receptacle module substrate 12 formed on a movable substrate, and the cap moves along with mounting receptacle module 12. Mounting receptacle module cap 33, together with the mounting receptacle module, can pivot around hinge 19. Besides, a cap 38 is arranged on one surface of the corner portion.

FIG. 24 is a plan view showing a state when the earphone receptacle is exposed. In the state shown in FIG. 23, cap 38 is disengaged from mounting receptacle module cap 33, and then mounting receptacle module cap 33 and mounting receptacle module substrate 12 are pivoted around hinge 19. It is desirable that cap 38 is made of a flexible material, for example, so that it can be deformed to accept the pivoting of the mounting receptacle module.

With the very simple mechanism used in the structure described above, the design of the slim-type casing while not using the earphone is not impaired and, when using the earphone, the earphone receptacle is exposed to allow the easy fixing of the earphone plug.

### Seventh Embodiment

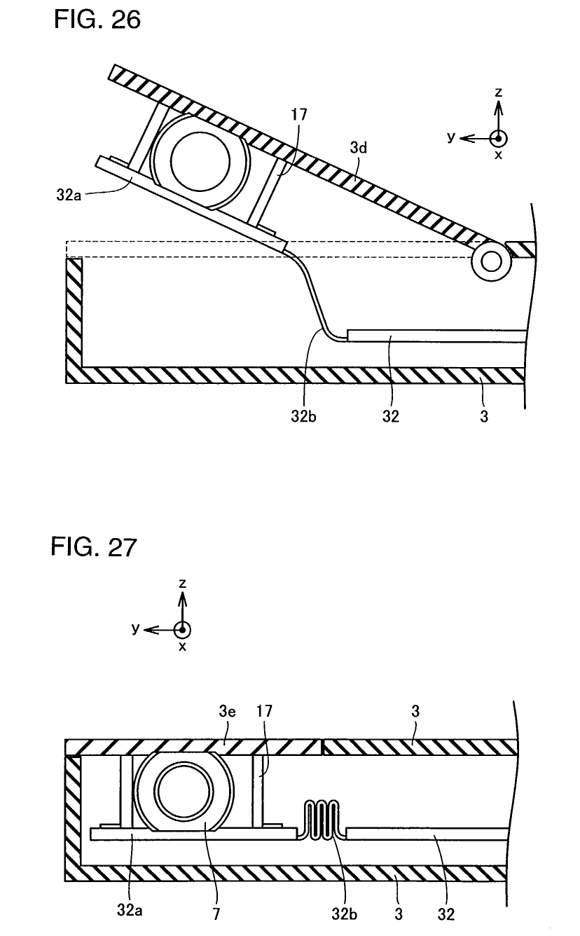

FIGS. 25 and 26 are cross-sectional views showing an arrangement of an earphone receptacle in a seventh embodiment of the present invention. In FIG. 25, the axis of hinge 19 is parallel to the x axis. That is, the axis of the hinge is parallel to the direction of the width of the mobile phone device. Earphone receptacle 7 is attached to receptacle substrate portion 32a. Folded joint portion 32b is arranged between receptacle substrate portion 32a and substrate body portion 32. A gearing joint member 17 is arranged between casing pivoting portion 3d and receptacle substrate portion 32a.

As shown in FIG. 26, when casing pivoting portion 3d is pivoted around hinge 19, receptacle substrate portion 32a joined to gearing joint member 17 also moves toward upper right direction. This movement of receptacle substrate portion 32a, which is greater than the pivoting of casing pivoting portion 3d around the hinge, is made possible by unfolding the overlap in joint portion 32b.

Though the arrangement of the receptacle described above has rather large mechanism because the accommodated structure pivots around the axis lying in the direction of the width of the mobile phone device, with this arrangement, the design of the slim-type casing while not using the earphone is not impaired and, when using the earphone, the earphone receptacle is exposed to allow the easy fixing of the earphone plug.

### Eighth Embodiment

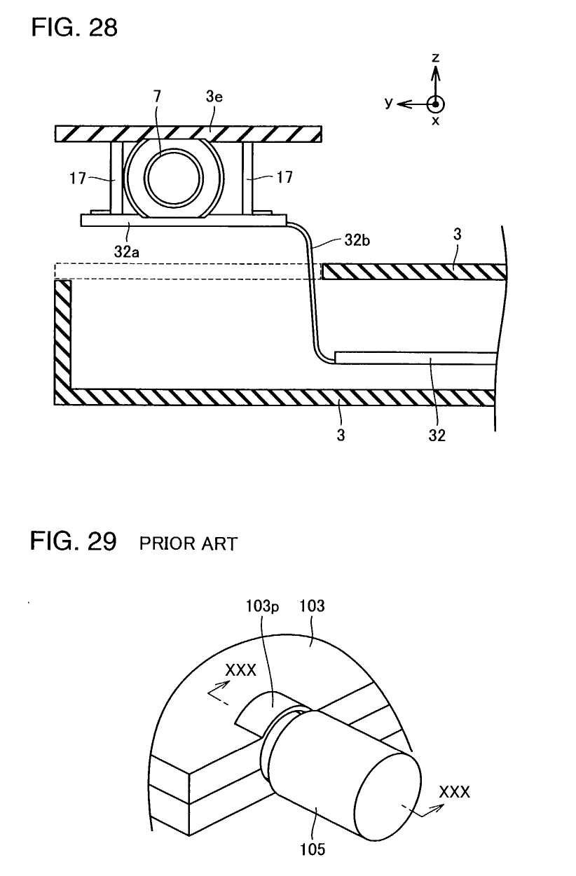

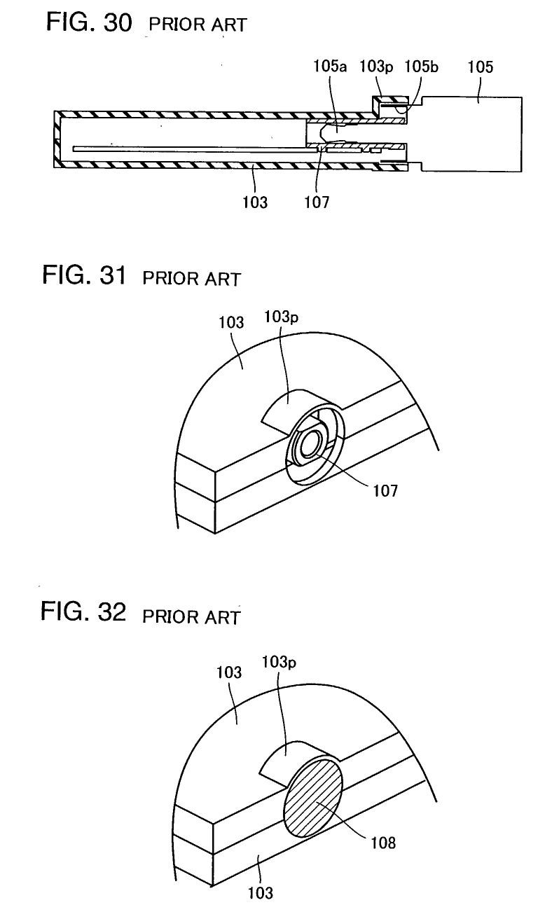

FIGS. 27 and 28 are cross-sectional views showing an arrangement of an earphone receptacle in an eighth embodiment of the present invention. In FIG. 27, casing portion 3e for out-of-surface movement is arranged as a member independent from body casing 3. Earphone receptacle 7 is attached to receptacle substrate portion 32a. Folded joint portion 32b is arranged between receptacle substrate portion 32a and substrate body portion 32. Gearing joint member 17 is arranged between casing portion 3e for out-of-surface movement and receptacle substrate portion 32a.

Joint portion 32b is desirably formed with a flexible material. When the earphone is not used, casing movement portion 3e is integrated with the body casing portion. When the earphone is used, however, casing portion 3e for out-of-surface movement is made movable. At that time, since joint portion 32b is formed with a flexible material, earphone receptacle 7 receives the force and is pushed in the direction of the thickness, together with receptacle substrate portion 32a and casing movement portion 3e which are joined to each other with gearing joint member 17.

With this, the design of the slim-type casing while not using the earphone is not impaired and, when using the earphone, the earphone receptacle is exposed in a surprising manner with the structure similar to a jack-in-the-box, and allows the easy fixing of the earphone plug.

In any of the arrangements of the receptacles in the first to eighth embodiments as described above, the side portion of the receptacle is connected with the ring contact provided on the plug. When the plug has the ring contact, it is particularly needed to provide a bulge on the casing around the receptacle, which bulge impairs the design of the slim-type casing. This need for providing a bulge on the casing is caused by covering the ring contact portion of the plug with the casing and forming the outer surface with the casing while the plug is fitted. It is unnecessary for the casing, however, to construct the outer surface while the plug is fitted. It will not be a disadvantage to have the outer surface with the plug in a bare state, if a proper measure for the receptacle, such as dustproof, is taken. Therefore, the design is given priority without providing a bulge on the portion of the casing where the bulge was needed. It is then possible (a) to remove the portion of the casing which portion interferes as the plug is fitted, (b) to provide an opening mechanism which makes a large aperture on the casing, (c) to provide an opening/closing mechanism to allow the casing around the receptacle assume the state of (a) mentioned above, or (d) to provide a receptacle moving mechanism which moves the receptacle so that the receptacle is exposed from the casing. In each case, the original design of the casing is ensured, and the interference in the fitting of the plug can be prevented by preventing the casing from covering a prescribed area of the side portion of the receptacle.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An arrangement of a receptacle for arranging a receptacle, in which a plug is fitted, inside a casing of electronic equipment, wherein
said receptacle is arranged such that said plug is fitted from a side portion of said casing, and
said casing has a notch provided on an end portion thereof so as to expose at least a side portion of said receptacle.

2. The arrangement of the receptacle according to claim 1, wherein
said receptacle is arranged to be accommodated within the end portion of said casing.

3. The arrangement of the receptacle according to claim 1, wherein
the side portion of said receptacle is connected with a ring contact provided on said plug.

4. The arrangement of the receptacle according to claim 1, wherein
said casing has a flat shape, and said receptacle has a flat surface intersecting the direction of the thickness of said casing.

5. An arrangement of a receptacle for arranging a receptacle, in which a plug is fitted, inside a casing of electronic equipment, comprising:
an opening/closing mechanism opening and closing a part of the casing near said receptacle.

6. The arrangement of the receptacle according to claim 5, comprising:
a receptacle moving mechanism moving a part of said receptacle to the outside of said casing.

7. The arrangement of the receptacle according to claim 6, comprising:
a linkage gearing said opening/closing mechanism to said receptacle moving mechanism.

8. The arrangement of the receptacle according to claim 6, comprising:
a rotation axis; and
a pivoting mechanism pivoting a part of said casing, which part is joined to be geared to said receptacle, around said rotation axis together with said receptacle.

9. The arrangement of the receptacle according to claim 6, wherein
said receptacle is located in a corner portion of said casing.

10. The arrangement of the receptacle according to claim 9, comprising:
a mechanism to enable the operation that,
while the front side of said receptacle is kept facing one side wall forming said corner portion, the other side wall portion forming said corner is separated and moved, together with said receptacle, away from said one side wall to protrude outer from said the other side wall.

11. The arrangement of the receptacle according to claim 5, wherein
the side portion of said receptacle is connected with a ring contact provided on said plug.

12. The arrangement of the receptacle according to claim 5, wherein
said receptacle is mounted on a movable substrate.

13. The arrangement of the receptacle according to claim 12, comprising:
a extendable folded joint portion joining a body substrate and said movable substrate.

14. The arrangement of the receptacle according to claim 13, wherein
said folded joint portion is formed with a flexible material.

15. The arrangement of the receptacle according to claim 5, wherein
said casing has a flat shape, and said receptacle has a flat surface intersecting the direction of the thickness of said casing.

16. A mobile device provided, within a casing thereof, with a receptacle in which a plug is fitted, comprising:
an arrangement of the receptacle wherein a portion of said casing fronting to at least a side portion of said receptacle is eliminated.

17. The mobile device according to claim 16, wherein
said casing has a notch provided on an end portion thereof, and said receptacle places at least said side portion within said notch.

18. The mobile device according to claim 16, comprising:
an opening/closing mechanism opening and closing a part of the casing near said receptacle.

19. The mobile device according to claim 18, comprising:
a receptacle moving mechanism moving a part of said receptacle to the outside of said casing.

20. The mobile device according to claim 16, wherein
said casing has a flat shape, and said receptacle has a flat surface intersecting the direction of the thickness of said casing.
